(19) United States
(12) Patent Application Publication
(10) Pub. No.: US 2024/0228779 A1
(43) Pub. Date: Jul. 11, 2024

(54) RESIN COMPOSITION

(71) Applicant: NAN YA PLASTICS CORPORATION, TAIPEI (TW)

(72) Inventors: Te-Chao Liao, TAIPEI (TW); Wei-Ru Huang, TAIPEI (TW); Hung-Yi Chang, TAIPEI (TW); Chia-Lin Liu, TAIPEI (TW)

(73) Assignee: NAN YA PLASTICS CORPORATION, TAIPEI (TW)

(21) Appl. No.: 18/170,529

(22) Filed: Feb. 17, 2023

(30) Foreign Application Priority Data
Dec. 23, 2022 (TW) 111149617

(51) Int. Cl. C08L 79/04; C08L 71/12; C08L 79/08

(52) U.S. Cl. CPC C08L 79/04; C08L 71/12; C08L 79/08; C08L 2201/02; C08L 2205/025; C08L 2205/035

(57) ABSTRACT

A resin composition includes CE resin, BMI resin, and a modified polyphenylene ether resin has a following general formula:

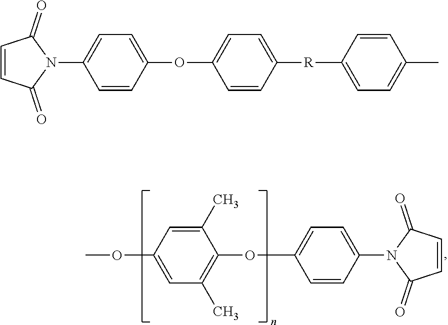

wherein R represents a chemical group of a bisphenol compound located between two hydroxyphenyl functional groups thereof, and n is an integer ranging from 3 to 25.

### CROSS-REFERENCE TO RELATED APPLICATION

This application claims the priority benefit of Taiwan application serial no. 111149617, filed on Dec. 23, 2022. The entirety of the above-mentioned patent application is hereby incorporated by reference herein and made a part of this specification.

### BACKGROUND

### Technical Field

The disclosure relates to a resin composition.

### Description of Related Art

A bismaleimide triazine (BT) resin-based system derived from cyanate resin (triazine) and bismaleimide resin is a resin composition with high rigidity, low thermal expansion coefficient, high glass transition temperature (Tg), and high peeling strength, etc., are widely used in different industrial fields, therefore, how to improve the resin composition mainly based on the BT resin-based system, such that it can competitive is an urgent goal for those skilled in the art to develop.

### SUMMARY

The disclosure provides a resin composition, which can effectively improve its performance in terms of glass transition temperature, thermal expansion coefficient, peel strength, water absorption, heat resistance, dielectric constant, and/or dielectric loss in the BT resin-based system, such that it can be competitive.

A resin composition of the disclosure includes cyanate ester resin, bismaleimide resin and modified polyphenylene ether resin having following structural formula:

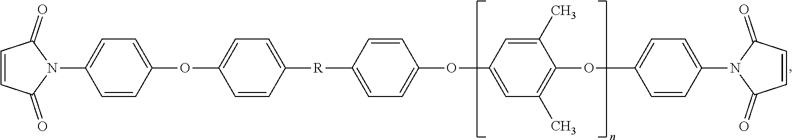

wherein R represents a chemical group of a bisphenol compound located between two hydroxyphenyl functional groups thereof, and n is an integer between 3 and 25.

In an embodiment of the disclosure, a weight ratio of the cyanate ester resin ranges from 20 wt % to 40 wt %.

In an embodiment of the disclosure, a weight ratio of the modified polyphenylene ether resin ranges less than or equal to 60 wt %.

In an embodiment of the disclosure, a weight ratio of the bismaleimide resin ranges less than or equal to 60 wt %.

In an embodiment of the disclosure, the resin composition further includes styrene resin, and a weight ratio of styrene resin ranges from 10 wt % to 30 wt %.

In an embodiment of the disclosure, the resin composition includes catalyst, flame retardant, silicon dioxide, silicone coupling agent, or a combination thereof.

In an embodiment of the disclosure, an amount of the catalyst ranges from 0.005 phr to 1 phr.

In an embodiment of the disclosure, an amount of the flame retardant ranges from 25 phr to 40 phr.

In an embodiment of the disclosure, a weight ratio of silicon dioxide ranges from 40 wt % to 70 wt %.

In an embodiment of the disclosure, an amount of the silicone coupling agent ranges from 0.1 phr to 5 phr.

Based on the above, the disclosure mainly uses BT resin-based systems in the resin composition, combining cyanate ester resin as a cross-linking agent with modified polyphenylene ether resin with a specific structural formula, in this way, good reactivity is produced through the functional group interaction between cyanate ester resin and the aforementioned chemical structure of the modified polyphenylene ether resin, therefore, it can effectively improve its performance in terms of glass transition temperature, thermal expansion coefficient, peel strength, water absorption, heat resistance, dielectric constant and/or dielectric loss, etc., such that it can be competitive.

In order for the features and advantages of the disclosure to be more comprehensible, the following embodiments are cited and described in detail as follows.

### DESCRIPTION OF THE EMBODIMENTS

Hereinafter, an embodiment of the disclosure will be described in detail. However, these embodiments are exemplary, and the disclosure is not limited thereto.

Herein, a range indicated by “one value to another value” is a general representation which avoids enumerating all values in the range in the specification. Therefore, the record of a specific value range, any number within this numerical range and any smaller numerical range bounded by any number within that numerical range is contemplated as if such any number and such smaller numerical ranges were expressly written in the specification.

In this embodiment, the resin composition includes cyanate ester resin, bismaleimide resin and modified polyphenylene ether (PPE) resin having the structural formula (1), wherein R represents a chemical group of a bisphenol compound located between two hydroxyphenyl functional groups thereof, and n is an integer between 3 and 25. Accordingly, the disclosure mainly uses BT resin-based systems in the resin composition, combining cyanate ester resin as a cross-linking agent with modified polyphenylene ether resin with a specific structural formula, in this way, good reactivity is produced through the functional group interaction between cyanate ester resin and the aforementioned chemical structure of the modified polyphenylene ether resin, therefore, it can effectively improve its performance in term of glass transition temperature, thermal expansion coefficient, peel strength, water absorption, heat resistance, dielectric constant and/or dielectric loss, etc., such that it can be competitive. Here, modified polyphenylene ether resin and cyanate ester resin will be described in detail below.

### Structural Formula (1)

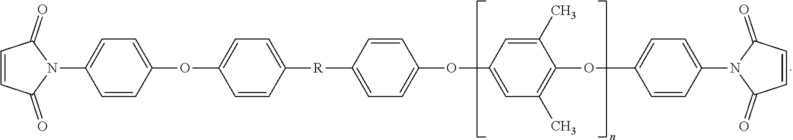

Furthermore, among many resin-based systems, the disclosure clearly demonstrates that for BT resin-based system, many characteristics of resin composition may be substantially improved, such as glass transition temperature, thermal expansion coefficient, peel strength, water absorption, heat resistance, dielectric constant and/or dielectric loss, based on this, the resin composition of the disclosure clearly demonstrates that it has beneficial effects in the application field of BT resin-based system.

In some embodiments, the resin composition may be applied to circuit board, wherein the dielectric constant of the circuit board made of the resin composition is 3.1 to 3.3, the dielectric loss is less than 0.025, the glass transition temperature is greater than 250° C., the thermal expansion coefficient is less than 15 ppm/° C., the peel strength is greater than 4 lb/in, and the water absorption rate is less than 0.35%, therefore, it may be a resin composition with low water resistance and low dielectric properties. For example, in the application field of 5G communication, in order to meet the needs of high-frequency transmission of circuit board, lower water absorption and lower dielectric properties are required, and the current BT resin-based system often has problems with water absorption and high dielectric properties, therefore, the disclosure clearly demonstrates that the reactivity of modified polyphenylene ether resin and cyanate ester resin can effectively reduce the water absorption and dielectric properties of BT resin-based system, that is to say, the resin composition of the disclosure can have substantially improved technical performance when applied to 5G communication, but the disclosure is not limited thereto.

### Cyanate Ester Resin

In some embodiments, the cyanate ester resin such as BA230 and PT60 of cyanate ester resin with cyanate functional group produced by Lonza, but the disclosure is not limited thereto.

In some embodiments, the weight ratio of cyanate ester resin ranges from 20 wt % to 40 wt % (for example, 20 wt %, 25 wt %, 30 wt %, 35 wt %, 40 wt % or any value within the above-mentioned 20 wt % to 40 wt %), based on the total weight of the resin of the resin composition, but the disclosure is not limited thereto.

### Modified Polyphenylene Ether Resin

The manufacturing method of the modified polyphenylene ether resin includes the following steps in sequence. It must be noted that the sequence of the steps and the actual operation method in this embodiment may be adjusted according to the needs, and are not limited to the embodiment.

A large molecular weight polyphenylene ether (PPE) resin material is provided, and the large molecular weight polyphenylene ether resin material has a first number average molecular weight (Mn), wherein the first number average molecular weight (Mn) of the large molecular weight polyphenylene ether resin material is not less than 18,000, and preferably not less than 20,000, but the disclosure is not limited thereto.

The general chemical structural formula (1-1) of the large molecular weight polyphenylene ether resin material is as follows, where n is an integer between 150 and 330 and preferably between 165 and 248,

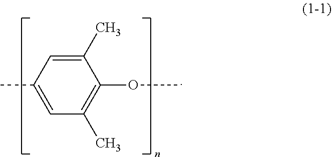

In some embodiments, the polyphenylene ether resin material may also be called polyphenylene oxide (PPO). The polyphenylene ether resin material has excellent insulation, acid and alkali resistance, excellent dielectric constant, and lower dielectric loss. Therefore, the polyphenylene ether resin material has better electrical properties, and the polyphenylene ether resin material is more suitable for use as an insulating substrate material for high-frequency printed circuit board, but the disclosure is not limited thereto.

After the large molecular weight polyphenylene ether resin material is provided, a cracking process is performed, such that the large molecular weight polyphenylene ether resin material is cracked to form a small molecular weight polyphenylene ether resin material having a second number average molecular weight and modified with a bisphenol functional group (also known as, small molecule PPE with phenolic end groups), and the second number average molecular weight is smaller than the first number average molecular weight (that is, the number average molecular weight of polyphenylene ether resin materials before cracking), wherein the second number average molecular weight (Mn) of the small molecular weight polyphenylene ether resin material is not greater than 12,000, and preferably not greater than 10,000, but the disclosure is not limited thereto.

More specifically, the cracking process includes: a bisphenol (phenolic material) and the large molecular weight polyphenylene ether resin material having the first number average molecular weight (namely, large molecular weight PPE), reacting in the presence of peroxides, such that the large molecular weight polyphenylene ether resin material is cracked to form the small molecular weight polyphenylene ether resin material, which has the second number average molecular weight smaller than the first number average molecular weight, and one side of the polymer chain of the small molecular weight polyphenylene ether resin material is modified with the phenolic functional group, and its general chemical structural formula (1-2) is as follows, wherein, R represents the chemical group of the bisphenol compound located between its two hydroxyphenyl functional groups,

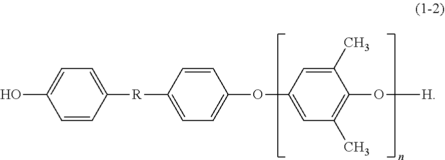

For example, as shown in Table 2 below, R may be, for example, a direct bond, methylene, ethylidene, isopropylidene, 1-methylpropyl, sulfone, or fluorene), wherein n is an integer between 3 and 25, and preferably between 10 and 18. In some embodiments, the number average molecular weight (Mn) of the small molecular weight polyphenylene ether resin material is generally between 500 g/mol and 5,000 g/mol, preferably between 1,000 g/mol and 3,000, and particularly preferably between 1,500 g/mol and 2,500 g/mol. In addition, the weight average molecular weight (Mw) of the small molecular weight polyphenylene ether resin material is usually between 1,000 g/mol and 10,000 g/mol, preferably between 1,500 g/mol and 5,000 g/mol, and particularly preferred is between 2,500 g/mol and 4,000 g/mol, but the disclosure is not limited thereto.

In some embodiments, the bisphenol compound is selected from the group consisting of 4,4′-biphenol, bisphenol A, bisphenol B, bisphenol S, bisphenol fluorene, 4,4′-ethylidenebisphenol, 4,4′-dihydroxydiphenylmethane, 3,5,3′,5′-tetramethyl-4,4′-dihydroxybiphenyl, and 2,2-Bis(3,5-dimethyl-4-hydroxyphenyl)propane, at least one of the group of materials formed. The types of the bisphenol compounds are shown in Table 1 below.

TABLE 1

| item | bisphenol compound | CAS No. |
|---|---|---|
| 1 | 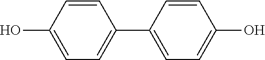 [SMILES: Oc1ccc(-c2ccc(O)cc2)cc1] | 92-88-6 (4,4′-biphenol) |
| 2 | 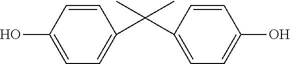 [SMILES: CC(C)(c1ccc(O)cc1)c1ccc(O)cc1] | 80-05-7 (bisphenol A) |
| 3 | 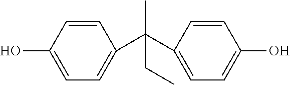 [SMILES: CCC(C)(c1ccc(O)cc1)c1ccc(O)cc1] | 77-40-7 (bisphenol B) |
| 4 | 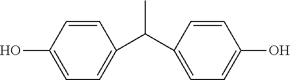 [SMILES: CC(c1ccc(O)cc1)c1ccc(O)cc1] | 2081-08-5 (4,4′-ethylidenebisphenol) |
| 5 | 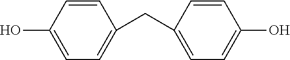 [SMILES: Oc1ccc(Cc2ccc(O)cc2)cc1] | 620-92-8 (4,4′- dihydroxydiphenylmethane) |
| 6 | 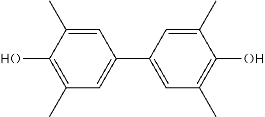 [SMILES: Cc1cc(-c2cc(C)c(O)c(C)c2)cc(C)c1O] | 2417-04-1 (3,5,3′,5′-tetramethyl-4,4′- dihydroxybiphenyl) |
| 7 | 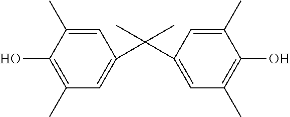 [SMILES: Cc1cc(C(C)(C)c2cc(C)c(O)c(C)c2)cc(C)c1O] | 5613-46-7 (2,2-Bis(3,5-dimethyl-4- hydroxyphenyl)propane) |
| 8 | 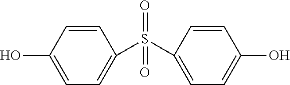 [SMILES: O=S(=O)(c1ccc(O)cc1)c1ccc(O)cc1] | 80-09-1 (bisphenol S) |
| 9 | 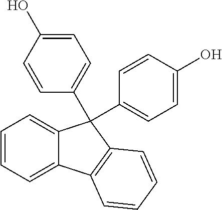 [SMILES: Oc1ccc(C2(c3ccc(O)cc3)c3ccccc3-c3ccccc32)cc1] | 3236-71-3 (bisphenol fluorene) |

The chemical groups located between the two hydroxyphenyl functional groups of the above bisphenol compounds are shown in Table 2.

TABLE 2

| | | chemical groups located between the two |
|---|---|---|
| | | hydroxyphenyl functional groups of the |
| item | bisphenol compound | bisphenol compound |
| 1 | 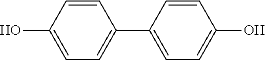 [SMILES: Oc1ccc(-c2ccc(O)cc2)cc1] | direct bond |
| 2 | 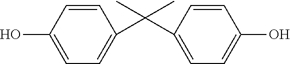 [SMILES: CC(C)(c1ccc(O)cc1)c1ccc(O)cc1] | isopropylidene |
| 3 | 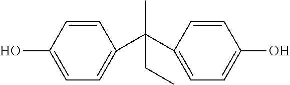 [SMILES: CCC(C)(c1ccc(O)cc1)c1ccc(O)cc1] | 1-methylpropyl(or sec-butyl) |
| 4 | 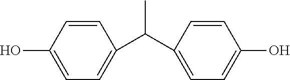 [SMILES: CC(c1ccc(O)cc1)c1ccc(O)cc1] | ethylidene |
| 5 | 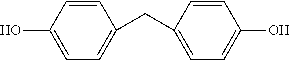 [SMILES: Oc1ccc(Cc2ccc(O)cc2)cc1] | methylene |
| 6 | 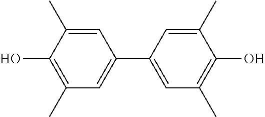 [SMILES: Cc1cc(-c2cc(C)c(O)c(C)c2)cc(C)c1O] | direct bond |
| 7 | 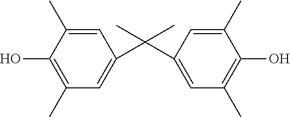 [SMILES: Cc1cc(C(C)(C)c2cc(C)c(O)c(C)c2)cc(C)c1O] | isopropylidene |
| 8 | 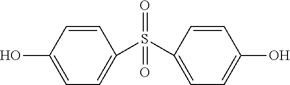 [SMILES: O=S(=O)(c1ccc(O)cc1)c1ccc(O)cc1] | sulfone |
| 9 | 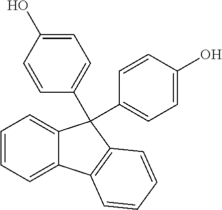 [SMILES: Oc1ccc(C2(c3ccc(O)cc3)c3ccccc3-c3ccccc32)cc1] | fluorene |

In some embodiments, the material of the peroxide is at least one selected from the group consisting of azobisisobutyronitrile, benzyl peroxide, and dicumyl peroxide. The material types of the peroxide are shown in Table 3 below.

TABLE 3

| item | peroxide | CAS No. |
|---|---|---|
| 1 | 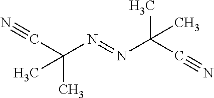 | 78-67-1 (azobisiso- butyronitrile) |
| 2 | 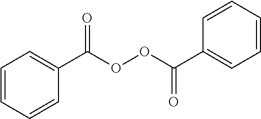 [SMILES: O=C(OOC(=O)c1ccccc1)c1ccccc1] | 94-36-0 (benzyl peroxide) |
| 3 | 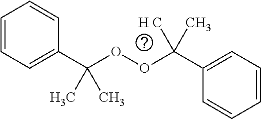 | 80-43-3 (dicumyl peroxide) |

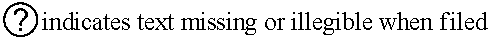

After a cracking process is performed, a nitrification process is performed, such that the small molecular weight polyphenylene ether resin material is subjected to the nitration reaction, and further, the two ends of the polymer chain of the small molecular weight polyphenylene ether resin material are respectively modified with a nitro functional group (also known as terminal nitro PPE), and its general chemical structural formula (1-3) is as follows,

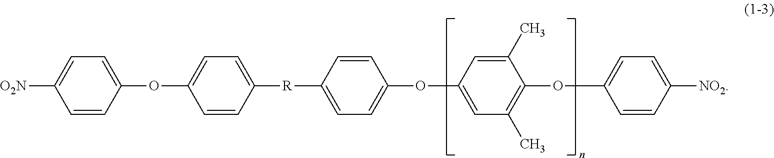

More specifically, the nitration process includes: using a 4-halo nitrobenzene material and the small molecular weight polyphenylene ether resin material that has been cracked and modified with the bisphenol functional group to perform the nitration in an alkali environment, such that the two ends of the polymer chain of the small molecular weight polyphenylene ether resin material are respectively modified with nitro functional groups. The nitration is carried out with the 4-halo nitrobenzene material and the small molecular weight polyphenylene ether resin material in an alkaline environment, and the end of the polymer chain of the small molecular weight polyphenylene ether resin material will form negatively charged oxygen ions. The negatively charged oxygen ion is easy to attack 4-halo nitrobenzene, and the halogen of 4-halo nitrobenzene is removed, and the nitrobenzene functional group is further respectively modified to the two ends of the polymer chain of the small molecular weight polyphenylene ether resin material. That is to say, the two ends of the polymer chain of the small molecular weight polyphenylene ether resin material may be respectively modified with nitro functional groups through the above reaction mechanism.

In some embodiments, the nitration process is to make the polyphenylene ether resin material perform nitration in an alkaline environment with a pH value between 8 and 14, and preferably between 10 and 14, but the disclosure is not limited thereto.

In some embodiments, the general chemical structural formula of the 4-halo nitrobenzene material is

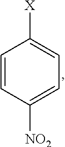

and the material types are shown in Table 4 below, and preferably X is fluorine element (F), chlorine element (CI), bromine element (Br), or iodine element (I).

TABLE 4

| item | 4-halo nitrobenzene | CAS No. |
|---|---|---|
| 1 | 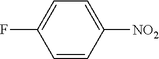 | 350-46-9 |
| 2 | 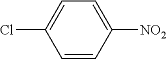 | 100-00-5 |
| 3 | 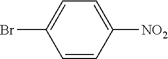 | 586-78-7 |
| 4 | 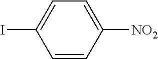 | 636-98-6 |

After the nitrification process is performed, a hydrogenation process is performed, such that the small molecular weight polyphenylene ether resin material with nitro functional groups respectively modified at both ends of the polymer chain is hydrogenated and reduced to the two ends of the chain are respectively modified with amino functional groups of the small molecular weight polyphenylene ether resin material (terminal amine group PPE), and its general chemical structural formula (1-4) is as follows,

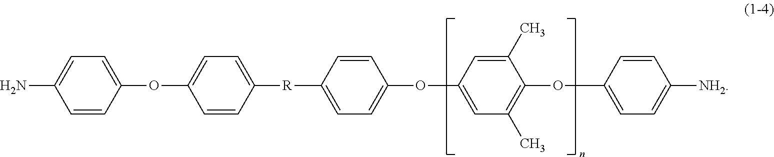

More specifically, the hydrogenation process includes: performing a hydrogenation reaction with the small molecular weight polyphenylene ether resin material having nitro functional groups respectively modified at two ends of the polymer chain with a hydrogenation solvent, wherein, the material type of the hydrogenation solvent is selected from at least one of the material groups includes the dimethylacetamide (DMAC, CAS No. 127-19-5), the tetrahydrofuran (THF, CAS No. 109-99-9), the toluene (CAS No. 108-88-3), and the isopropanol (CAS No. 67-63-0). In some embodiments, the use of dimethylacetamide as the hydrogenation solvent can enable the hydrogenation process to achieve an excellent hydrogenation conversion rate (such as the hydrogenation conversion rate greater than 99%), but the disclosure is not limited thereto. It is worth mentioning that the parameters controlling the hydrogenation conversion rate include: (1) solvent selection and the ratio of mixed solvents, (2) catalyst addition amount, (3) hydrogenation reaction time, (4) hydrogenation reaction temperature, and (5) hydrogenation reaction pressure. The material types of the hydrogenated solvent are shown in Table 5 below.

TABLE 5

| item | hydrogenation solvent | CAS No. |
|---|---|---|
| 1 | 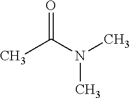 | 127-19-5 (N,N-dimethylacetamide) |
| 2 | 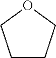 | 109-99-9 (tetrahydrofuran) |
| 3 | 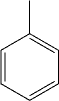 | 108-88-3 (toluene) |
| 4 | 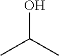 | 67-63-0 (isopropanol) |

After the hydrogenation process is performed, a synthesis process is performed, which includes: the small molecular weight polyphenylene ether resin material with amino functional groups (that is, Terminal amine group PPE) respectively modified the two ends of the polymer chain formed in the above hydrogenation process is synthesized with maleic anhydride to synthesize a modified polyphenylene ether resin, it general chemical structural formula (1-5) is as follows,

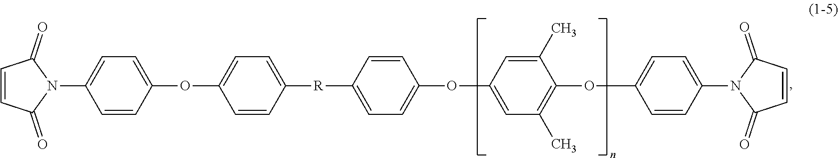

wherein R represents a chemical group of a bisphenol compound located between its two hydroxyphenyl functional groups, and n is an integer between 3 and 25, and preferably between 10 and 18, the chemical structure of maleic anhydride is as follows,

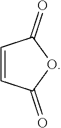

More specifically, in the synthesis process, the small molecular weight polyphenylene ether resin material (that is, the terminal amine group PPE) whose two ends of the polymer chain are respectively modified with amino functional groups is first mixed with maleic anhydride to perform a ring-opening reaction, and the synthetic process further uses p-toluene-sulfonic acid as a dehydrating agent to perform a ring-closing reaction, and then the modified polyphenylene ether resin is synthesized. It is worth mentioning that the small molecular weight polyphenylene ether resin material whose two ends of the polymer chain are respectively modified with the bismaleimide formed in above step, its chemical structure has polyphenylene ether of main chain, while the terminal position of the polymer chain is modified into a reactive group with high heat resistance (namely, bismaleimide). Thereby, the synthesized resin material has relatively low dielectric constant and dielectric loss. According to the above series of material modification procedures, the large molecular weight polyphenylene ether resin material may be cracked into a small molecular weight polyphenylene ether resin material, and the molecular structure of the small molecular weight polyphenylene ether resin material may be modified with bisphenol functional group, and the two ends of the polymer chain of the small molecular weight polyphenylene ether resin material are further modified with bismaleimide.

In some embodiments, the weight of the modified polyphenylene ether resin ranges from less than or equal to 60 wt % (for example, 5 wt %, 10 wt %, 20 wt %, 30 wt %, 40 wt %, 60 wt % or any value within the above-mentioned less than or equal to 60 wt %), based on the total weight of the resin of the resin composition, but the disclosure is not limited thereto.

In some embodiments, the resin composition further includes the bismaleimide resin, which may be phenylmethane maleimide resin (CAS number: 67784-74-1; such as BMI-2300 (made by Daiwa Chemical Industry Co., Ltd., trade name, such as structural formula (A)), bis-(3-ethyl-5-methyl-4-maleimidephenyl)methane (CAS number: 105391-33-1; such as BMI-70 (manufactured by KI Chemical Co., trade name, such as structural formula (B))), or a combination thereof, but the disclosure is not limited thereto.

### Structural Formula (A)

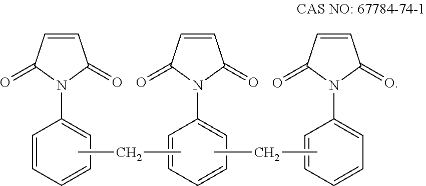

### Structural Formula (B)

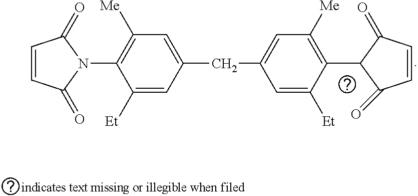 [SMILES: CCc1cc(Cc2cc(C)c(N3C(=O)C=CC3=O)c(CC)c2)cc(C)c1C1C(=O)C=CC1=O]

In some embodiments, the weight ratio of the bismaleimide resin ranges less than or

equal to 60 wt % (for example, 5 wt %, 10 wt %, 20 wt %, 30 wt %, 40 wt %, 60 wt % or any value within the above-mentioned less than or equal to 60 wt %), based on the total weight of resin of the resin composition, but the disclosure is not limited thereto.

In some embodiments, the weight ratio of phenylmethane maleimide resin ranges less than or equal to 40 wt % (for example, 0 wt %, 10 wt %, 20 wt %, 30 wt %, 40 wt % or any value within the above-mentioned less than or equal to 40 wt %), and the weight ratio of bis-(3-ethyl-5-methyl-4-maleimidephenyl)methane ranges from 0 wt % to 30 wt % (for example, 0 wt %, 5 wt %, 10 wt %, 20 wt %, 30 wt % or any value within the range from 0 wt % to 30 wt %), based on the total weight of resin of the resin composition, wherein at least one of phenylmethane maleimide resin and bis-(3-ethyl-5-methyl-4-maleimidephenyl)methane is not 0 wt %, but the disclosure is not limited thereto.

In some embodiments, the resin composition further includes styrene resin, wherein the styrene (SB) resin has the 10% to 40% of styrene-based ratio, the 60% to 90% of 1,2 vinyl ratio, and the 10% to 30% of 1,4 vinyl ratio. The molecular weight (MW) of the styrene resin is about 3500 to 5500. Furthermore, by using SBS resin instead of liquid rubber, the phase separation between the resin may be improved, and the fluidity and filling properties may be improved, thereby enhancing the overall processability while maintaining low dielectric properties, but the disclosure is not limited thereto.

In some embodiments, the weight ratio of the styrene resin ranges from 10 wt % to 30 wt % (for example, 10 wt %, 15 wt %, 20 wt %, 30 wt % or any value within the above 10 wt % to 30 wt %), based on the total weight of the resin of the resin composition, but the disclosure is not limited thereto.

In some embodiments, resin composition also includes the catalyst, the flame retardant, the silicon dioxide, the silicone coupling agent, or a combination thereof, wherein the amount of catalyst ranges from 0.005 phr to 1 phr (for example, 0.005 phr, 0.01 phr, 0.05 phr, 0.1 phr, 0.5 phr, 1 phr or any value within the above 0.005 phr to 1 phr), the amount of flame retardant ranges from 25 phr to 40 phr (for example, 25 phr, 30 phr, 32 phr, 34 phr, 38 phr, 40 phr or any value within the above 25 phr to 40 phr), the weight ratio of silicon dioxide ranges from 40 wt % to 70 wt % (for example, 40 wt %, 45 wt %, 50 wt %, 55 wt %, 60 wt %, 70 wt % or any value within the above-mentioned 40 wt % to 70 wt %), the amount of silicone coupling agent used ranges from 0.1 phr to 5 phr (for example, 0.1 phr, 0.5 phr, 1 phr, 2 phr, 3 phr, 5 phr or any value within the above 0.1 phr to 5 phr), but the disclosure is not limited thereto. In here, the unit of phr may be defined as the parts by weight of other materials added per 100 parts by weight of the resin of the resin composition, and the weight ratio of silicon dioxide is based on the weight of the resin of the resin composition plus the weight of the flame retardant, wherein the resin of the resin composition is, for example, cyanate ester resin, styrene resin, bismaleimide resin, modified polyphenylene ether resin, or a combination thereof.

In some embodiments, the catalyst may be 2-ethyl 4-methylimidazole (2E4MZ; CAS: 931-36-2;

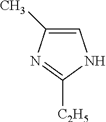

) to catalyze better reactivity of the resin during thermal curing, but the disclosure is not limited thereto.

In some embodiments, the flame retardant is a halogen-free flame retardant and a specific example may be a phosphorus-based flame retardant, which may be selected from phosphate esters, such as: triphenyl phosphate (TPP), resorcinol diphosphate (RDP), bisphenol A bis (diphenyl) phosphate (BPAPP), bisphenol A bis (dimethyl) phosphate (BBC), resorcinol diphosphate (CR-733S), resorcinol-bis(di-2,6-dimethylphenyl phosphate) (PX-200); it may be selected from phosphazenes, such as polybis(phenoxy)phosphazene (SPB-100); ammonium polyphosphate, melamine phosphate (MPP), melamine cyanurate; may be selected from more than one combination of DOPO flame retardants, such as DOPO (such as structural formula (C)), DOPO-HQ (such as structural formula (D)), double DOPO derivative structure (such as structural formula (E)), etc.; aluminum-containing hypophosphite lipids (such as structural formula (F)),

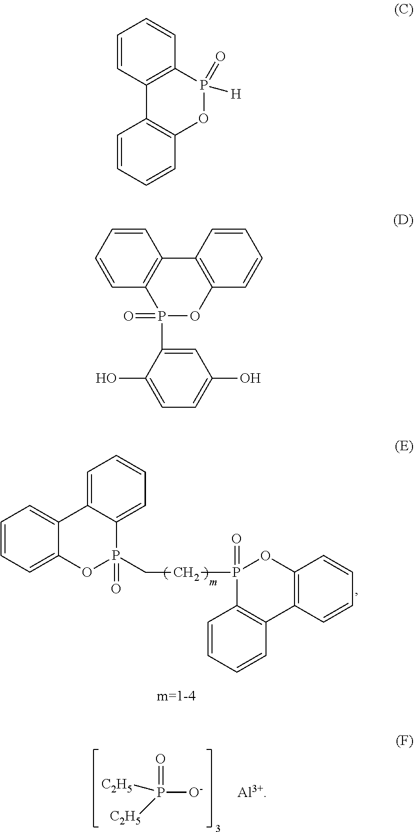

In some embodiments, the silicon dioxide is a spherical silicon dioxide and may preferably be prepared using a synthetic method to reduce electrical properties and maintain fluidity and gel filling properties, wherein the spherical silicon dioxide has acrylic or vinyl of surface modification, the purity is above 99.0%, and the average particle diameter (D50) is about 2.0 micrometers (μm) to 3.0 μm, but the disclosure is not limited thereto.

In some embodiments, the silicone coupling agent may include, but is not limited to, siloxane compounds. In addition, according to the type of functional group, it may be divided into amino silane compounds, epoxy silane compounds, vinyl silane compounds, ester silane compounds, hydroxyl silane compounds, isocyanate silane compounds, methylacryloxysilane compounds and acryloxy silane compounds to enhance the compatibility and cross-linking degree of the glass fiber cloth and powder in the circuit board, but the disclosure is not limited thereto.

It should be noted that the resin composition of the disclosure can be processed into prepregs and copper clad substrates (CCL) according to actual design requirements, and the specific implementations listed above are not limitations of the disclosure, as long as the resin composition includes all belong to the scope of protection of the disclosure.

The following examples and comparative examples are listed to illustrate the effects of the disclosure, but the protection scope of the disclosure is not limited to the scope of the examples.

The copper foil substrates in the respective examples and comparative examples were evaluated based on the following methods.

The glass transition temperature (C) is tested with a dynamic mechanical analyzer (DMA).

Water absorption (%): after the sample is heated in a pressure cooker at 120° C. and 2 atm for 120 minutes, calculate the weight change before and after heating.

The 288° C. solder resistance and heat resistance (seconds): after the sample is heated in a pressure cooker at 120° C. and 2 atm for 120 minutes, it is immersed in a soldering furnace at 288° C., and the time required for the sample to explode and delaminate is recorded.

The dielectric constant (Dk): the dielectric constant (Dk) is measured at a frequency of 10 GHz by the Agilent E4991A dielectric analyzer.

The dielectric loss (Df): the dielectric loss (Df) is measured at a frequency of 10 GHz by the Agilent E4991A dielectric analyzer.

The thermal expansion coefficient (CTE) is tested with a thermomechanical analyzer (TMA).

Copper foil peel strength (lb/in): the peel strength between the copper foil and the circuit carrier is tested.

### Examples 1 to 4 and Comparative Example 1

The resin composition in Table 1 is mixed with toluene to form a varnish of a thermosetting resin composition, and the varnish is impregnated with NAN YA fiberglass cloth (NAN YA PLASTICS CORPORATION; cloth type: 1078LD) at room temperature, then dried at 130° C. (by an impregnation machine) for a few minutes to obtain a prepreg with a resin content of 70 wt %. Lastly, four pieces of prepregs are layered on top of each other between two copper foils with a 35 μm thickness, and kept at a constant temperature for 20 minutes at a pressure of 25 kg/cm² and a temperature of 85° C., and after heated to 210° C. at a heating rate of 3° C./min, it is kept at a constant temperature for another 120 minutes, and then slowly cooled to 130° C. to obtain a 0.59 mm thick copper foil substrate. In here, the modified polyphenylene ether resin in Table 6 is cracked small molecule PPE (Mn=1,600) and placed in a solvent to dissolve in dimethylacetamide, potassium carbonate and tetrafluoronitrobenzene are added, the temperature is raised to 140° C., and the temperature is lowered after 8 hours of reaction to room temperature, filtered to remove the solid, the solution is precipitated with methanol/water, and the precipitate is the product (PPE-NO₂); the product is then placed in the solvent (dimethylacetamide), hydrogenated at 90° C. for 8 hours, it is PPE-NH₂; the product is placed in toluene, maleic anhydride and p-toluenesulfonic acid are added, the temperature is raised to 120° C. and refluxed, and the reaction is performed for 8 hours to obtain the modified polyphenylene ether resin.

The physical properties of the copper foil substrate as prepared were tested, and the results are shown in Table 6 in detail. After comparing the results of Examples 1 to 4 and Comparative Example 1 in Table 6, the following conclusions may be drawn: compared with Comparative Example 1, Examples 1 to 4 may effectively improve its performance in terms of glass transition temperature, thermal expansion coefficient, peel strength, water absorption, heat resistance, dielectric constant and/or dielectric loss, etc.

TABLE 6

| | | | | | | | | | | Comparative | |
|---|---|---|---|---|---|---|---|---|---|---|---|
| | | Example | | | | | | | | Example | |
| | | 1 | | 2 | | 3 | | 4 | | 1 | |
| Resin | cyanate ester resin | 30 | wt % | 30 | wt % | 30 | wt % | 30 | wt % | 30 | wt % |
| (100 | (BA230) | | | | | | | | | | |
| parts by | bismaleimide resin | 30 | wt % | 30 | wt % | 15 | wt % | 0 | | 30 | wt % |
| weight | (BMI-2300) | | | | | | | | | | |
| in total) | bismaleimide resin | 10 | wt % | 0 | | 0 | | 0 | | 20 | wt % |
| | (BMI-70) | | | | | | | | | | |
| | styrene resin (SBS) | 20 | wt % | 20 | wt % | 20 | wt % | 20 wt | % | 20 | wt % |
| | modified | 10 | wt % | 20 | wt % | 35 | wt % | 50 wt | % | 0 | |
| | polyphenylene ether | | | | | | | | | | |
| | resin | | | | | | | | | | |
| Other | flame retardant (Jinyi | 30 | phr | 30 | phr | 30 | phr | 30 | phr | 30 | phr |
| additives | Chemical PQ60) | | | | | | | | | | |
| (relative | silica | 60 | wt % | 60 | wt % | 60 | wt % | 60 | wt % | 60 | wt % |
| to 100 | catalyst (2E4MZ) | 0.05 | phr - | 0.05 | phr | 0.05 | phr | 0.05 | phr - | 0.05 | phr |
| parts by | silicone coupling agent | 1 | phr | 1 | phr | 1 | phr | 1 | phr | 1 | phr |
| weight | (methacryloxysilane | | | | | | | | | | |
| of resin) | compound) | | | | | | | | | | |

| B-stage curing temperature | 130° | C. | 130° | C. | 130° | C. | 130° | C. | 130° | C. |
|---|---|---|---|---|---|---|---|---|---|---|
| Glass transition temperature | 285° | C. | 277° | C. | 262° | C. | 255° | C. | 292° | C. |
| thermal expansion coefficient | 10 ppm/° C. | | 11 ppm/° C. | | 13 ppm/° C. | | 14 ppm/° C. | | 10 ppm/° C. | |
| Peel strength | 5.72 | lb/in | 5.89 | lb/in | 6.12 | lb/in | 6.87 | lb/in | 5.56 | lb/in |
| water absorption (PCT ½ hour) | 0.31% | | 0.27% | | 0.24% | | 0.21% | | 0.38% | |
| heat resistance (PCT ½ hour) | Pass | | Pass | | Pass | | Pass | | Pass | |
| water absorption (PCT 2 hour) | 0.39% | | 0.35% | | 0.32% | | 0.29% | | 0.49% | |
| heat resistance (PCT 2 hour) | Pass | | Pass | | Pass | | Pass | | Pass | |
| dielectric constant | 3.36/0.00278 | | 3.34/0.00251 | | 3.35/0.00221 | | 3.35/0.00198 | | 3.38/0.00312 | |
| (Dk)/dielectric loss | | | | | | | | | | |
| (Df)(measurement frequency | | | | | | | | | | |
| 10 GHz) | | | | | | | | | | |

It should be noted that although the above-mentioned circuit board is used as an example, the application field of the BT resin-based system of the disclosure is not limited to the field of circuit boards, and others such as those skilled in the art can equally fields such as water-absorbing and heat-resistant coating material all belong to the protection scope of the disclosure.

In summary, the disclosure mainly uses BT resin-based systems in the resin composition, combining cyanate ester resin as a cross-linking agent with modified polyphenylene ether resin with a specific structural formula, in this way, good reactivity is produced through the functional group interaction between cyanate ester resin and the aforementioned chemical structure of the modified polyphenylene ether resin, therefore, it can effectively improve its performance in terms of glass transition temperature, thermal expansion coefficient, peel strength, water absorption, heat resistance, dielectric constant and/or dielectric loss, etc., such that it can be competitive.

Although the disclosure has been disclosed in the above embodiments, the embodiments are not intended to limit the disclosure. Persons skilled in the art may make some changes and modifications without departing from the spirit and scope of the disclosure. The protection scope of the disclosure shall be defined by the appended claims.

What is claimed is:

1. A resin composition, comprising:
cyanate ester resin;
bismaleimide resin; and
modified polyphenylene ether resin, having following structural formula: 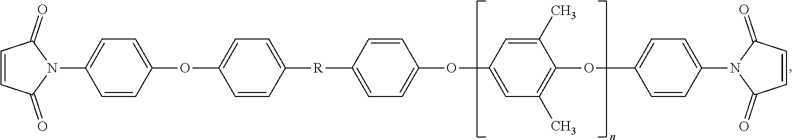
wherein R represents a chemical group of a bisphenol compound located between two hydroxyphenyl functional groups thereof, and n is an integer between 3 and 25.

2. The resin composition according to claim 1, wherein a weight ratio of the cyanate ester resin ranges from 20 wt % to 40 wt %.

3. The resin composition according to claim 1, wherein a weight ratio of the modified polyphenylene ether resin ranges less than or equal to 60 wt %.

4. The resin composition according to claim 1, wherein a weight ratio of the bismaleimide resin ranges less than or equal to 60 wt %.

5. The resin composition according to claim 1, further comprising: styrene resin, wherein a weight ratio of the styrene resin ranges from 10 wt % to 30 wt %.

6. The resin composition according to claim 1, further comprising: catalyst, flame retardant, silicon dioxide, silicone coupling agent, or a combination thereof.

7. The resin composition according to claim 6, wherein an amount of the catalyst ranges from 0.005 phr to 1 phr.

8. The resin composition according to claim 6, wherein the flame retardant ranges from 25 phr to 40 phr.

9. The resin composition according to claim 6, wherein a weight ratio of the silicon dioxide ranges from 40 wt % to 70 wt %.

10. The resin composition according to claim 6, wherein an amount of the silicone coupling agent ranges from 0.1 phr to 5 phr.
